(19) United States
(12) Patent Application Publication
(10) Pub. No.: US 2019/0149795 A1
(43) Pub. Date: May 16, 2019

(54) THREE DIMENSIONAL IMAGING USING LINE SCAN CAMERA

(71) Applicants: JIN YOUNG SOHN, FULLERTON, CA (US); GYOUNG IL CHO, FULLERTON, CA (US); CHEONG SOO SEO, BREA, CA (US)

(72) Inventors: JIN YOUNG SOHN, FULLERTON, CA (US); GYOUNG IL CHO, FULLERTON, CA (US); CHEONG SOO SEO, BREA, CA (US)

(73) Assignee: STEREO DISPLAY, INC., ANAHEIM, CA (US)

(21) Appl. No.: 15/813,137

(22) Filed: Nov. 14, 2017

(51) Int. Cl. H04N 13/02; G06T 7/571

(52) U.S. Cl. CPC H04N 13/0235; H04N 13/0253; H04N 13/0221; G06T 7/571; G06T 2207/10144; G06T 2207/10028; G06T 2207/10148; G06T 2207/10152; H04N 2213/001

(57) ABSTRACT

The present invention comprises a line scan camera and a variable focus optical element. With the line scan camera, the three dimensional imaging system of the present invention can overcome the speed problems of the area sensor and the variable focus optical element (Micromirror Array Lens) can change depth as fast as the line scan camera refreshes for the next scan so that the line scan camera and the variable focus optical element can be coupled to control optical depth and the linear scan. With help of the present invention scheme, three dimensional scan can be achieved with only one path scan of the line scan. Scheme, apparatus, and method are disclosed in the present invention.

### FIELD OF THE INVENTION

The present invention relates to general three dimensional imaging system and more specifically three dimensional imaging and line scan camera application.

### BACKGROUND OF THE INVENTION

There are many three dimensional imaging and display technologies which has been long studied since twentieth century. There are so many different three dimensional imaging systems as well as so many three dimensional display technologies to represent an object in three dimensional space. One issue with three dimensional imaging was always speed of the image taking since lots of images are required to have three dimensional information. The most popular three dimensional imaging technology is using stereoscopic imaging technique which acquires depth information from a scene in the form that the parallax phenomenon of human eyes is simulated. When human eyes see a scene, right and left side eyes have two different perspectives due to their separation. The brain fuses these two perspectives and assesses the visual depth with triangulation method. Like human eyes do, stereoscopic three dimensional imaging systems take two perspective images by two cameras that are disposed to view the scene from different angles at the same time as disclosed in U.S. Pat. No. 5,432,712 to Chan. These devices, however, tend to be large and heavy, and come at high cost due to multiple camera systems and their optical axis separation requirement.

In the image taking field, many image taking techniques were developed. But due to large data transfer, currently many area cameras have bottleneck of capturing speed. One of solution was using line scan camera. Since it has only a few lines (or single line), relatively image sensor structure is simple and fast. Also it can have really fast speed compared with area sensor. In the market, usual line scan camera has more than 300 times faster than the area cameras with similar resolution. In FIG. 1, the general line scan camera configuration is shown. Since line scan camera has only one dimensional configuration. It needs some means for object moving. In this figure, the object 11 is located on top of the translation stage operated by an electrically controlled motor 15. To have an exact position of the object 11, the position is controlled and measured with position or speed encoder 17. Also a photo sensor 16 is used for detecting samples. For the lines scan camera 14, line bar illumination 12 is usually used for the uniform illumination of the object in one dimensional direction. The reflected light from the object 11 is then focused onto the line scan camera through the imaging optics 13. The images from the line scan camera can be obtained through the image grabber interface 18, wherein the image grabber has coupled with the encoder 17 of the translation stage of the object 11. While the object 11 is moving, the line scan camera 14 continuously captures the line images. Since the line images and positions are coupled together, two dimensional images could be reconstructed in the image processing unit.

In FIG. 2, a configuration of three dimensional imaging system with line scan camera which uses triangulation method with two cameras with line scanning. An object 21 is located on translation stage. Figure shows cross-sectional image with line scanning plane. Left line scan camera 25 and right line scan camera 26 are located to have the same field of view through the optical imaging lenses. The field of view area is uniformly illuminated by the bar illumination source 24. Both line scan cameras 25, 26 share illumination 24. With triangulation corresponding lines 23, calculation with triangulation method can be applied to have the height of the object 21. These corresponding lines 23 formed through the center of the projection 22 with line scan cameras 25, 26 and the object 21. With this geometry, three dimensional information can be obtained by use of the triangulation method. But when the height is off from the reference plane, finding corresponding points or lines becomes more difficult and this difficulty reduces accuracy of the system. Detail configuration and methods are disclosed in EP Pat. No. 2,984,444 A1 to Liliemblum.

Another method is using laser displacement sensor. Usually laser displacement sensor comprises laser light source, linear collimating lens and collecting lens and linear sensor (or area sensor for line sensing). Basically laser displacement sensor is based on triangulation methods. Given the know relative position of the laser emitter and the optical sensor detector, the position of the target can be calculated by determining the location of the reflected beam spot of the detector sensor. When the sensor is line type, displacement (or distance) is measured by the position of the detector spot where the laser light from the emitter is imaged. When this one dimensional sensor is arrayed in orthogonal direction, the sensor can detect line three dimensional profile. In addition to this line three profiles, sample can be scanned with along the other orthogonal direction. With this orthogonal direction scanning, line three dimensional profile becomes surface three dimensional profiles. This surface profiles can give three dimensional profiles for the objects. This method is relatively new but spreading more and more. With triangulation, this laser displacement method can give very high accuracy. One major disadvantage is that angle sensitivity and sensor resolution limits the distance range and field of view of the optical system.

To overcome the disadvantages of the previous technologies, the present invention introduces line scan camera configuration with variable focus optical element. To increase speed of the optical system, line scan camera is introduced and the depth scan of the system the variable focus optical element is introduced into the system. Also this line scan camera and the variable focus optical element are coupled together to have scan with depth and line scan.

### SUMMARY OF THE INVENTION

The present invention contributes to enhance speed of the three dimensional imaging by using line scan camera instead of the area sensor camera. The present invention comprises a line scan camera and a variable focus optical element. With the line scan camera, the three dimensional imaging system of the present invention can overcome the speed problems of the area sensor and the variable focus optical element (Micromirror Array Lens) can change depth as fast as the line scan camera refreshes for the next scan so that the line scan camera and the variable focus optical element can be coupled to control optical depth and the linear scan. With help of the present invention scheme, three dimensional scan can be achieved with only one path scan of the line scan. Scheme, apparatus, and method are disclosed in the present invention.

The main idea of the present invention of three dimensional imaging using line scan camera uses properties of rapidity and repeatability of the variable focus optical element and the line scan camera. Thanks to the rapidity and repeatability of the variable focus optical element and the line scan camera, three dimensional scanning becomes feasible with only one scan of the object through the line scan camera. Line scan camera gives a good speed of the scan but it needs multiple scan of the object to have multi-focus three dimensional images and there is very little time to change focus of the imaging optics. The present invention comprises a variable focusing optical element of high speed and this variable focus element changes depth of the imaging optics for taking three dimensional image without losing the advantages of the line scan camera.

First line scan camera and the scanning device form an imaging system with one dimensional image plus another dimension scan to make two dimensional images. Then the variable focus optical element (Micromirror Array Lens) makes another orthogonal scan for the object. These three axes of the line scan camera, scanning axis of the scanning device, and depth scan of the variable focus optical element make three dimensional axes of the scan imaging device. These components and properties make a three dimensional imaging system with line scan camera of the present invention.

For the specific three dimensional purpose of the three dimensional imaging, scanning device, line scan camera, and the variable focus optical element should be coupled with each other to match the dimension of the object.

When the variable focus optical element is changed with a mean of changing optical property, the system can be transformed for taking multi configuration image taking system with various optical parameters. In the present invention, only one scan is enough for scanning the multiple configuration of the optical parameter since those parameter is changed alternatively to form a completer image for individual optical parameters.

Three dimensional imaging system with line scan camera of the present invention comprises a line scan camera, an imaging optics wherein the imaging optics determines base optical power of the three dimensional imaging system with line scan camera, a variable focus optical element wherein the variable focus optical element changes focal plane of the imaging system, and a scanning device wherein the scanning device moves the line scan camera or objects (an object) relatively with each other, wherein one of the line scan camera or the objects is moved for relative motion, wherein said variable focus optical element scans objects in optical depth dimension and the line scan camera scans the objects with relative motion of the line scan camera and the objects.

The line scan camera of the present invention is coupled with variable focus optical element. The line scan camera of the present invention alternatively captures depth images varying images with changing the focal plane of the imaging system. The imaging optics of the present invention images the object onto the line scan camera through the variable focus optical element.

The variable focus optical element of the present invention varies base optical power of the three dimensional imaging system. The variable focus optical element of the present invention comprises a variable focus lens. The variable focus optical element of the present invention comprises a variable focus mirror. The variable focus optical element of the present invention comprises a Micromirror Array Lens, wherein the Micromirror Array Lens satisfy phase matching condition and convergence condition of the optical system.

The line scan camera of the present invention comprises a stripe type area mode. the line scan camera of the present invention scans depth scan happens while the scan area changes. The variable focus optical element of the present invention changes focal plane while passing the strip type area in the line scan camera without building un-scanned area. The variable focus optical element of the present invention changes focal plane so that the line scan camera and the scanning device minimize un-scanned area of the system.

The present invention also discloses a method for three dimensional image taking by three dimensional imaging system with line scan camera comprising: determining base optical power of the three dimensional imaging system based on objects (an object) to be imaged; scanning relative position of the objects and a line scan camera, wherein the objects or the line scan move for scanning imaging field of view; changing focal plane of the variable focus optical element, wherein the variable focus optical element is coupled with scanning the relative position of the objects and the line scan camera; and taking images based on the focal plane of the variable focus optical element, wherein the taken images are processed to extract three dimensional information of the objects.

The method for three dimensional image taking by three dimensional imaging system with line scan camera of the present invention further comprises repeating focal plane changes for taking same depth images of the objects. The method for three dimensional image taking by three dimensional imaging system with line scan camera of the present invention further comprises changing optical parameters or the system. In the method for three dimensional image taking by three dimensional imaging system with line scan camera of the present invention, the optical parameters are illumination condition, exposure time, numerical aperture or focal distance of the imaging system.

The present invention of three dimensional imaging system with line scan camera comprises a line scan camera, an imaging optics wherein the imaging optics determines base optical power of the three dimensional imaging system with line scan camera, a mean for changing optical parameter of the system wherein the mean form changing optical parameter is coupled with the line scan camera, and a scanning device wherein the scanning device moves the line scan camera or objects (an object) relatively with each other, wherein one of the line scan camera or the objects is moved for relative motion, wherein said variable focus optical element scans objects in optical depth dimension and the line scan camera scans the objects with relative motion of the line scan camera and the objects.

The line scan camera of the present invention alternatively captures images with varying optical parameters such as illumination condition, exposure time, numerical aperture or focal distance of the imaging system. The three dimensional imaging system of the present invention further comprise a variable focus optical element. The imaging optics of the present invention images the object onto the line scan camera through the variable focus optical element.

The variable focus optical element of the present invention varies base optical power of the three dimensional imaging system. The variable focus optical element of the present invention comprises a variable focus lens. The variable focus optical element of the present invention comprises a variable focus mirror. The variable focus optical element comprises a Micromirror Array Lens, wherein the Micromirror Array Lens satisfies phase matching condition and convergence condition.

The line scan camera of the present invention comprises a stripe type area mode. The mean for changing optical parameter of the system of the present invention changes the optical parameters while the scan area changes. the mean for changing optical parameter of the system changes the optical parameter so that the scanning device and the line scan camera minimize un-scanned area of the system.

One of the main components of the present invention is a variable focus optical element to maintain high speed of the imaging system. A Micromirror Array Lens can be introduced to have high speed of the imaging system for varying focal planes of the three dimensional imaging system. In three dimensional imaging, especially depth from focus technique, high speed imaging is critical since lots of images should be taken and calculated at the same time. Since three dimensional imaging is calculated from the multiple images of the object, reliability and repeatability is a must condition for a good three dimensional imaging system. Micromirror Array Lens can give this high reliability and repeatability.

When the Micromirror Array Lens is used as a variable focus optical element, it can generate high speed of depth scanning. The Micromirror Array Lens can generate reliable and repeatable focal scanning as well as high enough speed for the imaging speed. With the Micromirror Array Lens, the main problem of the low speed of the three dimensional imaging system can be enhanced based on focus varying speed of the Micromirror Array Lens. The general principle and methods for making the Micromirror Array Lens are disclosed in U.S. Pat. No. 6,934,072 issued Aug. 23, 2005 to Kim, U.S. Pat. No. 6,934,073 issued Aug. 23, 2005 to Kim, U.S. Pat. No. 6,970,284 issued Nov. 29, 2005 to Kim, U.S. Pat. No. 6,999,226 issued Feb. 14, 2006 to Kim, U.S. Pat. No. 7,031,046 issued Apr. 18, 2006 to Kim, U.S. Pat. No. 7,095,548 issued Aug. 22, 2006 to Cho, U.S. Pat. No. 7,161,729 issued Jan. 9, 2007 to Kim, U.S. Pat. No. 7,239,438 issued Jul. 3, 2007 to Cho, U.S. Pat. No. 7,267,447 issued Sep. 11, 2007 to Kim, U.S. Pat. No. 7,274,517 issued Sep. 25, 2007 to Cho, U.S. Pat. No. 7,489,434 issued Feb. 10, 2009 to Cho, U.S. Pat. No. 7,619,807 issued Nov. 17, 2009 to Baek, and U.S. Pat. No. 7,777,959 issued Aug. 17, 2010 to Sohn, all of which are incorporated herein by references.

Moreover, the Micromirror Array Lens can generate more than order of magnitude longer length of the focal plane shift that that by piezo electric transducer, which is commonly used in the depth scan of the three dimensional microscope. Thus, the present invention with the Micromirror Array Lens can overcome short scanning range of the piezo-electric transducer driven three dimensional imaging system as well as low speed scanning limit of the three dimensional imaging system.

The present invention provides a high speed three dimensional scanning method. Since no macro-moving structure is used, vibration effect can be eliminated and thus good image quality with reliability can be obtained. Thanks to high scanning speed of the system, the present invention can be used in many industrial fields where three dimensional object images are essential.

Although the present invention is briefly summarized, the full understanding of the invention can be obtained by the following drawings, detailed descriptions, and appended claims.

### DESCRIPTION OF FIGURES

These and other features, aspects and advantages of the present invention will become better understood with reference to the accompanying drawings, wherein

FIG. 1 illustrates general configuration of line scan camera (prior art);

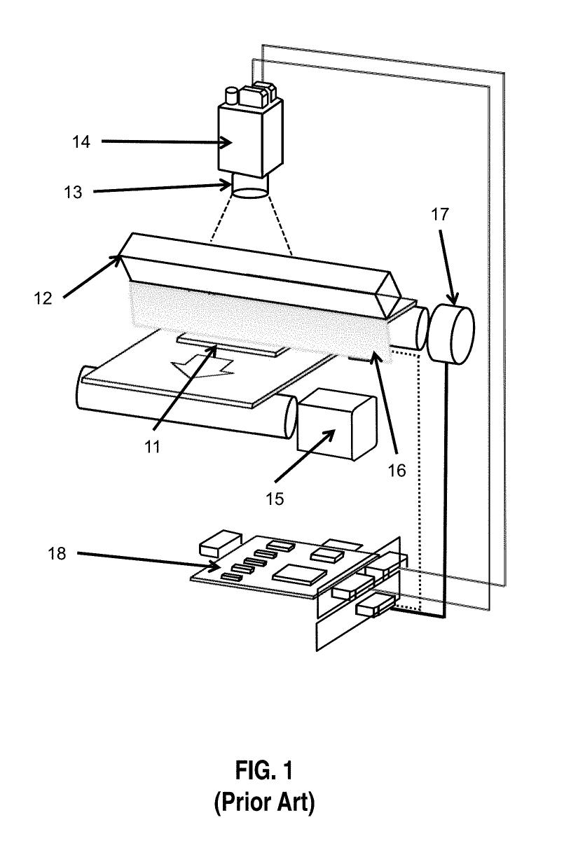

FIG. 2 illustrates schematic diagram of three dimensional line scan camera configuration with two cameras using triangulation method (prior art);

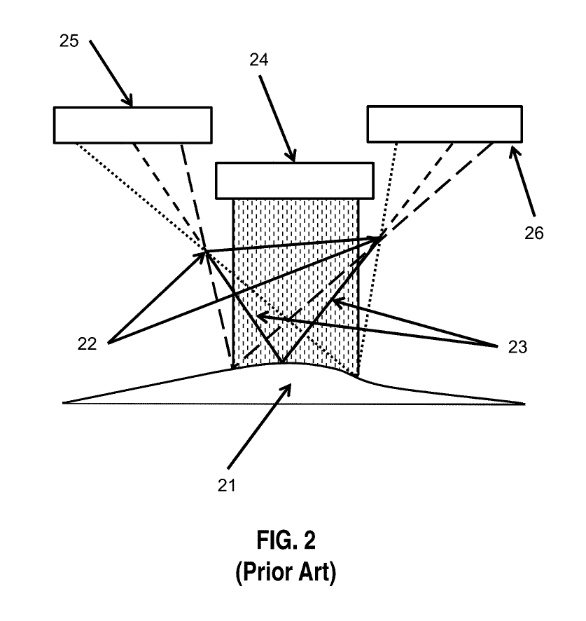

FIG. 3 illustrates schematic diagram of three dimensional imaging with line scan camera with variable focus optical element (Micromirror Array Lens);

FIG. 4 shows schematic configuration of three dimensional imaging system with variable focus optical element (Micromirror Array Lens) and co-axial illumination;

FIG. 5 shows schematic configuration of three dimensional imaging system with variable focus optical element (Micromirror Array Lens) and focus controlled co-axial illumination;

FIG. 6 schematic configuration of three dimensional imaging system with variable focus optical element (non-axis symmetric Micromirror Array Lens) and focus controlled co-axial illumination with scanning mirror for field of view control;

FIG. 7 shows three dimensional CAD drawing for three dimensional imaging system with variable focus optical element (Micromirror Array Lens) and focus controlled co-axial illumination captured by line scan camera;

FIG. 8 shows first depth image of conceptual scan geometry in time. 1A˜5A images are taken with same focus and form an image for whole field of view;

FIG. 9 shows second depth image of conceptual scan geometry in time. 1B˜5B images are taken with same focus and form an image for whole field of view;

FIG. 10 shows third depth image of conceptual scan geometry in time. 1C˜5C images are taken with same focus and form an image for whole field of view;

FIG. 11 shows fourth depth image of conceptual scan geometry in time. 1D˜5D images are taken with same focus and form an image for whole field of view;

FIG. 12 shows first depth image taken by the conceptual scan geometry in FIG. 8. 1A˜5A images are taken with same focus and stitched to form an image for whole field of view;

FIG. 13 shows second depth image taken by the conceptual scan geometry in FIG. 9. 1B˜5B images are taken with same focus and stitched to form an image for whole field of view;

FIG. 14 shows third depth image taken by the conceptual scan geometry in FIG. 10. 1C˜5C images are taken with same focus and stitched to form an image for whole field of view;

FIG. 15 shows fourth depth image taken by the conceptual scan geometry in FIG. 11. 1D˜5D images are taken with same focus and stitched to form an image for whole field of view;

FIG. 16 shows fifth image taken by the conceptual scan geometry in FIG. 8˜FIG. 11 (not shown). 1E˜5E images are taken with same focus and stitched to form an image for whole field of view;

FIG. 17 shows fifth image taken by the conceptual scan geometry in FIG. 8˜FIG. 11 (not shown). 1F˜5F images are taken with same focus and stitched to form an image for whole field of view;

FIG. 18 shows an AIF (all in focused) image from the three dimensional imaging system with line scan camera, which is made of images from FIG. 12˜FIG. 17 (more depth images are used);

FIG. 19 shows a contour plot of depth-map from the three dimensional imaging system with line scan camera, which is made of images from FIG. 12˜FIG. 17 (more depth images are used);

FIG. 20 shows a three dimensional reconstructed image of the object by the three dimensional imaging system with line scan camera, which is made of images from FIG. 12˜FIG. 17 (more depth images are used);

FIG. 21 shows a three dimensional reconstructed depth map of the object by the three dimensional imaging system with line scan camera, which is made of images from FIG. 12˜FIG. 17 (more depth images are used);

### DETAILED DESCRIPTION OF THE ILLUSTRATED EMBODIMENTS

The present invention of three dimensional imaging using line scan camera uses properties of rapidity and repeatability of the variable focus optical element. Thanks to the rapidity and repeatability of the variable focus optical element, three dimensional scanning becomes feasible with only one scan of the object through the line scan camera. Line scan camera gives a good speed of the scan but it needs multiple scan of the object to have multi-focus three dimensional images. There is very little time to change focus of the imaging optics. The present invention comprises a variable focusing optical element and this variable focus element changes depth of the imaging optics for taking three dimensional image.

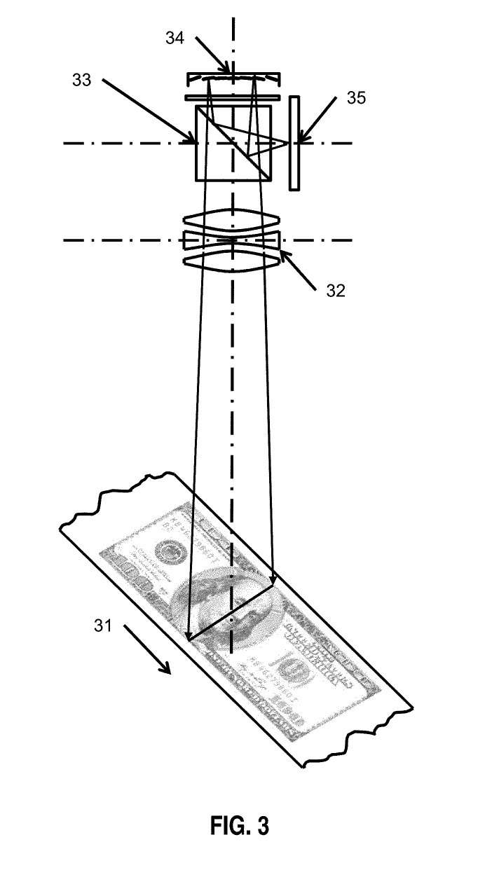

FIG. 3 shows schematic diagram of three dimensional imaging using line scan camera with variable focus optical element (Micromirror Array Lens). The object 31 is moving while scanning the imaging area. The object 31 can be moved with constant speed to have easier configuration of the imaging system. Also the object 31 can have uneven scanning speed if it is using encoder which reads the moving part position or speed. When the encoder is used, the object movement can be coupled with the imaging sensor 35 (line scan camera). The reflected light from the object 31 is then collected by the imaging optics 32. The imaging optics 32 can determine the field of view of the three dimensional imaging system and the basic optical parameters of the three dimensional imaging system. And furthermore, the imaging optics 32 can determine the reference depth of the three dimensional imaging system. Also beam splitter 33 can be used to maintain axial symmetry. Especially, polarization beam splitter can be used with waveplate, which can improve efficiency of the imaging system. From the reference scanning depth, wherein the variable optical element has no power, the scanning focal planes can be determined. The light from the imaging optics 32 is then focus changed by the variable focus optical element 34 (Micromirror Array Lens), which can determine the depth of the three dimensional imaging system. While scanning the depth of the optical system, line scan camera 35 captures images of the object. By changing multiple depths of the object alternatively, the camera can accumulate multiple depth information with only one scan. With smart combination of depth scanning and line scan camera 35 control, all the lateral images with multiple depths can be obtained. Especially by using small thickness of the line scan camera 35, the speed of the scanning can be improved. These days, line scan camera with area mode (stripe) such as TDI (time delay and integration) is very common. With this camera, area scan is not enough but can make small part of the image and the time between the image area movement can be used for switching other illumination or calculating the images. In the present invention, those stripe area line scan can give a time for changing depth of the optical system and scanning other depth images.

Also, in the present invention, other optical parameters can be changed such as illuminations, color of illumination while the depth of the optical system is maintained. In this case, the scanning system with line scan camera can take images with different condition. Preferably, the illumination is strobe-controlled to have short exposure time.

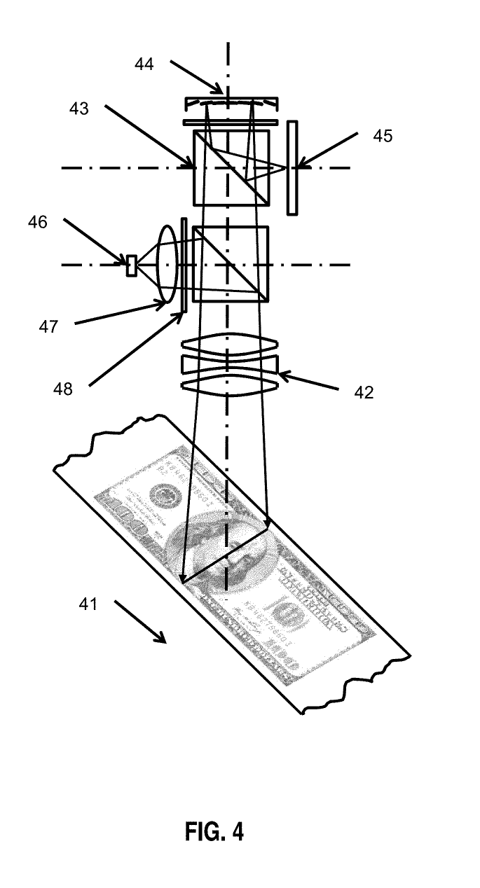

FIG. 4 shows schematic configuration of three dimensional imaging system with variable focus optical element (Micromirror Array Lens) and co-axial illumination. The object 41 is moving while scanning the imaging area. The object 41 can be moved with constant speed to have easier configuration of the imaging system. Also the object 41 can have uneven scanning speed if it is using encoder which reads the moving part position or speed. When the encoder is used, the movement of the object 41 can be coupled with the imaging sensor 45 (line scan camera). The reflected light from the object 41 is then collected by the imaging optics 42. The imaging optics 42 can determine the field of view of the three dimensional imaging system and the basic optical parameters of the three dimensional imaging system. And furthermore, the imaging optics 42 can determine the reference depth of the three dimensional imaging system.

And extra co-axial illumination components 46, 47, 48 can be implemented together to provide co-axial illumination of the imaging system. Light source 46 is collimated through the collimation lens 47. And the collimated illumination light can be modulated through the spatial light modulator 48. When a diffuser is used, diffused light can be used in the illumination system. In this configuration, beam splitter should be used for maintaining axial symmetry. Also polarization beam splitter with waveplate can be used for improving light efficiency. A beam splitter 43 in the variable focus optical element can be used to maintain axial symmetry of the variable focus optical element (Micromirror Array Lens). Especially, polarization beam splitter can be used with waveplate, which can improve efficiency of the imaging system.

From the reference scanning depth which is determined by the imaging optics 42, wherein the variable optical element has no power, the scanning focal planes can be determined. The light from the imaging optics 42 is then focus changed by the variable focus optical element 44 (Micromirror Array Lens), which can determine the depth of the three dimensional imaging system. While scanning the depth of the optical system, line scan camera 45 captures images of the object. By changing multiple depths of the object alternatively, the camera can accumulate multiple depth information with only one scan. With smart combination of depth scanning and line scan camera 45 control, all the lateral images with multiple depths can be obtained. Especially by using small thickness of the line scan camera, the speed of the scanning can be improved. These days, line scan cameras with area mode (stripe) such as TDI (time delay and integration) are very common. With these cameras, area scan is not enough but can make small part of the image and the time between the image area movement can be used for switching other illumination or calculating the images. In the present invention, those stripe area line scan can give a time for changing depth of the optical system and scanning other depth images.

Also, in the present invention, other optical parameters can be changed such as illuminations, color of illumination while the depth of the optical system is maintained. As well as co-axial illumination, other illumination can be used. Even exposure time dependency can be imaged with one scan of the line scan camera. In this case, the scanning system with line scan camera can take images with different conditions. Preferably, the illumination or other parameters are strobe-controlled to have a short scanning time.

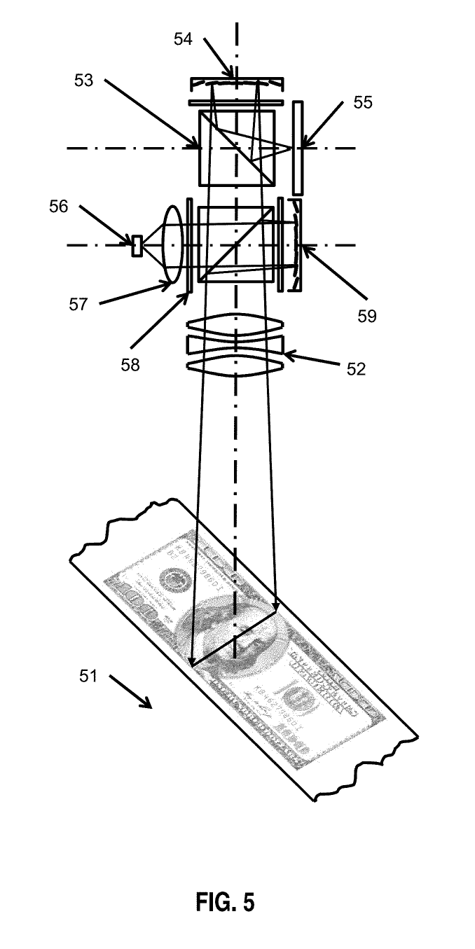

FIG. 5 shows a schematic configuration of three dimensional imaging system with variable focus optical element (Micromirror Array Lens) and focus controlled co-axial illumination. In this configuration, the illumination is also focus controlled to improve three dimensional imaging quality. The object 51 is moving while scanning the imaging area. The object 51 can be moved with constant speed to have easier configuration of the imaging system. Also the object 51 can have uneven scanning speed if it is using encoder which reads the moving part position or speed. When the encoder is used, the movement of the object 51 can be coupled with the imaging sensor 55 (line scan camera). The reflected light from the object 51 is then collected by the imaging optics 52. The imaging optics 52 can determine the field of view of the three dimensional imaging system and the basic optical parameters of the three dimensional imaging system. And furthermore, the imaging optics 52 can determine the reference depth of the three dimensional imaging system.

And extra co-axial illumination components 56, 57, 58 can be implemented together to provide co-axial illumination of the imaging system. Light source 56 is collimated through the collimation lens 57. In this configuration an extra variable focus element 59 can be used to improve image quality with controlling focus of the illumination. This controlled focus can improve contrast of the images, which can improve image depth calculation while extracting the depth information of the three dimensional imaging. And the collimated illumination light can be modulated through the spatial light modulator 58. When a diffuser is used, diffused light can be used in the illumination system. In this configuration, beam splitter should be used for maintaining axial symmetry. Also polarization beam splitter with waveplate can be used for improving light efficiency. A beam splitter 53 in the variable focus optical element can be used to maintain axial symmetry of the variable focus optical element (Micromirror Array Lens). Especially, polarization beam splitter can be used with waveplate, which can improve efficiency of the imaging system.

From the reference scanning depth which is determined by the imaging optics 52, wherein the variable optical element has no power, the scanning focal planes can be determined. The light from the imaging optics 52 is then focus changed by the variable focus optical element 54 (Micromirror Array Lens), which can determine the depth of the three dimensional imaging system. While scanning the depth of the optical system, line scan camera 55 captures images of the object. By changing multiple depths of the object alternatively, the camera can accumulate multiple depth information with only one scan. With smart combination of depth scanning and line scan camera 55 control, all the lateral images with multiple depths can be obtained. Especially by using small thickness of the line scan camera, the speed of the scanning can be improved. These days, line scan camera with area mode (stripe) such as TDI (time delay and integration) line scan camera is very common. With these cameras, area scan is not enough but can make small part of the image and the time between the image area movement can be used for switching other illumination or calculating the images. In the present invention, those stripe area line scan can give a time for changing depth of the optical system and scanning other depth images.

Also, in the present invention, other optical parameters can be changed such as illuminations, color of illumination while the depth of the optical system is maintained. As well as co-axial illumination, other illumination can be used. Even exposure time dependency can be imaged with one scan of the line scan camera. In this case, the scanning system with line scan camera can take images with different conditions. Preferably, the illumination or other parameters are strobe-controlled to have a short scanning time.

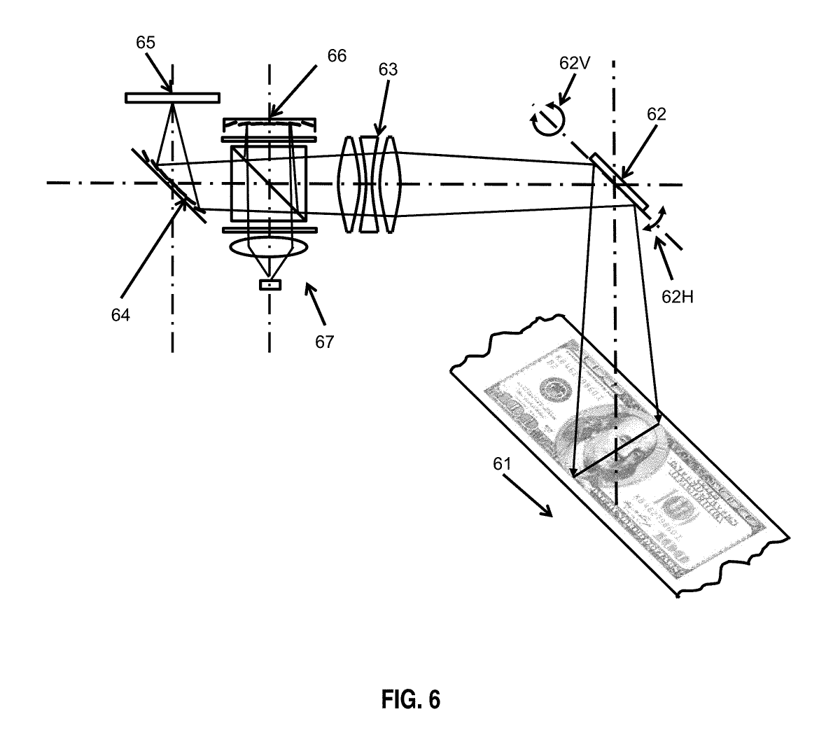

FIG. 6 schematic configuration of three dimensional imaging system with variable focus optical element (non-axis symmetric Micromirror Array Lens) and focus controlled co-axial illumination with scanning mirror for field of view control. With the scanning mirror 62 for field of view control, the imaging system can improve of accessibility of the three dimensional imaging system. Sometimes, it is difficult to access optically due to size of imaging device or the size and geometry of the object 61. In this configuration, the illumination is also focus controlled to improve three dimensional imaging quality and the field of view is controlled vertically 62V and horizontally 62H. And also, in this configuration, non-axis symmetry of the imaging

The object 61 is moving while scanning the imaging area. The object 61 can be moved with constant speed to have easier configuration of the imaging system. Also the object 61 can have uneven scanning speed if it is using encoder which reads the moving part position or speed. When the encoder is used, variable focus optical element 64 can be coupled with the imaging sensor 65 (line scan camera). The reflected light from the object 61 is then collected by the imaging optics 62. The imaging optics 62 can determine the field of view of the three dimensional imaging system and the basic optical parameters of the three dimensional imaging system. And furthermore, the imaging optics 62 can determine the reference depth of the three dimensional imaging system.

And extra co-axial illumination 67 can be implemented together to provide co-axial illumination of the imaging system. Light source is collimated through the collimation lens. In this configuration an extra variable focus element 66 can be used to improve image quality with controlling focus of the illumination. This controlled focus can improve contrast of the images, which can improve image depth calculation while extracting the depth information of the three dimensional imaging. And the collimated illumination light can be modulated through the spatial light modulator. When a diffuser is used, diffused light can be used in the illumination system. In this configuration, beam splitter should be used for maintaining axial symmetry. Also polarization beam splitter with waveplate can be used for improving light efficiency. In this configuration, a beam splitter is not required in the optical beam path, but the axis-symmetry is not maintained.

From the reference scanning depth which is determined by the imaging optics 63, wherein the variable optical element has no power, the scanning focal planes can be determined. The light from the imaging optics 63 is then focus changed by the variable focus optical element 64 (Micromirror Array Lens), which can determine the depth of the three dimensional imaging system. While scanning the depth of the optical system, line scan camera captures images of the object. By changing multiple depths of the object alternatively, the camera can accumulate multiple depth information with only one scan. With smart combination of depth scanning and line scan camera 65 control, all the lateral images with multiple depths can be obtained. Especially by using small thickness of the line scan camera, the speed of the scanning can be improved. These days, line scan camera with area mode (stripe) such as TDI (time delay and integration) line scan camera is very common. With these cameras, area scan is not enough but can make small part of the image and the time between the image area movement can be used for switching other illumination or calculating the images. In the present invention, those stripe area line scan can give a time for changing depth of the optical system and scanning other depth images.

Also, in the present invention, other optical parameters can be changed such as illuminations, color of illumination while the depth of the optical system is maintained. As well as co-axial illumination, other illumination can be used. Even exposure time dependency can be imaged with one scan of the line scan camera. In this case, the scanning system with line scan camera can take images with different conditions. Preferably, the illumination or other parameters are strobe-controlled to have a short scanning time.

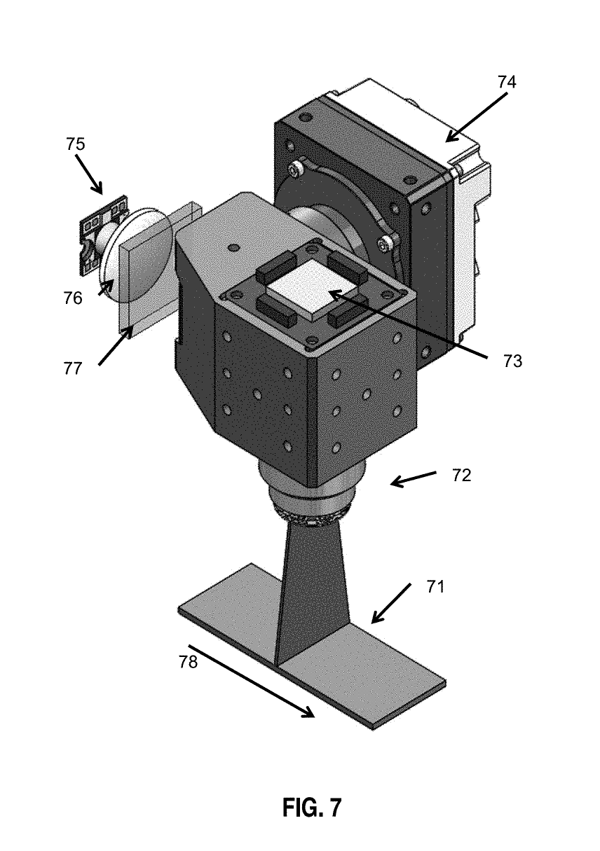

FIG. 7 shows three dimensional CAD drawing for three dimensional imaging system with variable focus optical element (Micromirror Array Lens) and focus controlled co-axial illumination captured by line scan camera. In this configuration, the illumination is also focus controlled to improve three dimensional imaging quality. The object 71 is moving while scanning the imaging area 78 with moving stage, preferably with position or speed encoder. The object 71 can be moved with constant speed to have easier configuration of the imaging system. Also the object 71 can have uneven scanning speed if it is using encoder which reads the moving part position or speed. When the encoder is used, object moving with stage can be coupled with the imaging sensor 74 (line scan camera). The reflected light from the object 71 is then collected by the imaging optics 72. The imaging optics 72 can determine the field of view of the three dimensional imaging system and the basic optical parameters of the three dimensional imaging system. And furthermore, the imaging optics 72 can determine the reference depth of the three dimensional imaging system.

And extra co-axial illumination components 75, 76, 77 can be implemented together to provide co-axial illumination of the imaging system. Light source 75 is collimated through the collimation lens 76. Preferably, Light Emitting Diodes (LED) can be used as a light source 75. In this configuration an extra variable focus element can be used to improve image quality with controlling focus of the illumination. This controlled focus can improve contrast of the images, which can improve image depth calculation while extracting the depth information of the three dimensional imaging. And the collimated illumination light can be modulated through the spatial light modulator 77. When a diffuser is used, diffused light can be used in the illumination system. In this configuration, beam splitter should be used for maintaining axial symmetry. Also polarization beam splitter with waveplate can be used for improving light efficiency. A beam splitter in the variable focus optical element can be used to maintain axial symmetry of the variable focus optical element (Micromirror Array Lens). Especially, polarization beam splitter can be used with waveplate, which can improve efficiency of the imaging system.

From the reference scanning depth which is determined by the imaging optics 72, wherein the variable optical element has no power, the scanning focal planes can be determined. The light from the imaging optics 72 is then focus changed by the variable focus optical element 73 (Micromirror Array Lens), which can determine the depth of the three dimensional imaging system. While scanning the depth of the optical system, line scan camera 74 captures images of the object. By changing multiple depths of the object alternatively, the camera can accumulate multiple depth information with only one scan. With smart combination of depth scanning and line scan camera 74 control, all the lateral images with multiple depths can be obtained. Especially by using small thickness of the line scan camera, the speed of the scanning can be improved. These days, line scan camera with area mode (stripe) such as TDI (time delay and integration) line scan camera is very common. With these cameras, area scan is not enough but can make small part of the image and the time between the image area movement can be used for switching other illumination or calculating the images. In the present invention, those stripe area line scan can give a time for changing depth of the optical system and scanning other depth images.

Also, in the present invention, other optical parameters can be changed such as illuminations, color of illumination while the depth of the optical system is maintained. As well as co-axial illumination, other illumination can be used. Even exposure time dependency can be imaged with one scan of the line scan camera. In this case, the scanning system with line scan camera can take images with different conditions. Preferably, the illumination or other parameters are strobe-controlled to have a short scanning time.

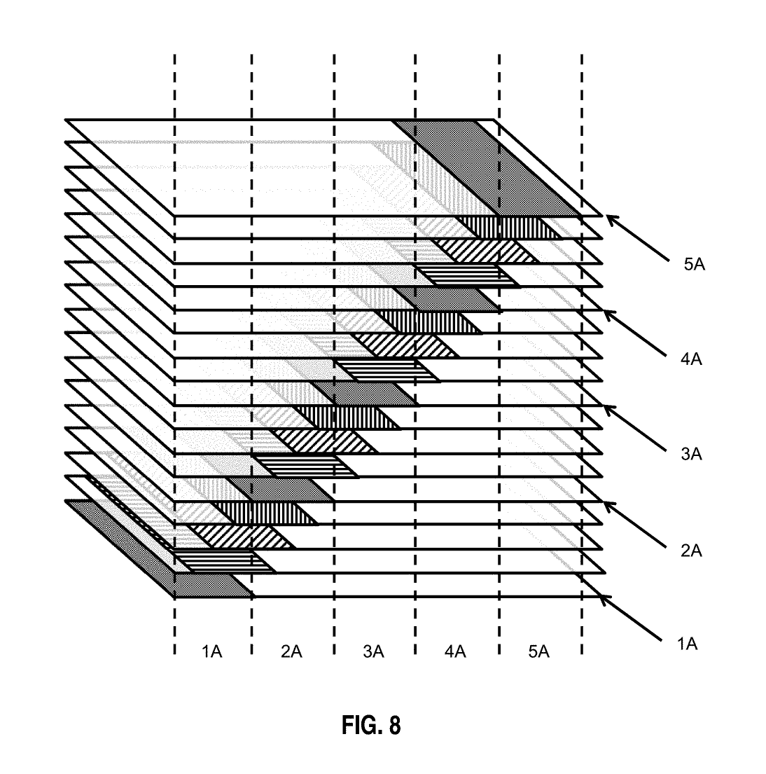

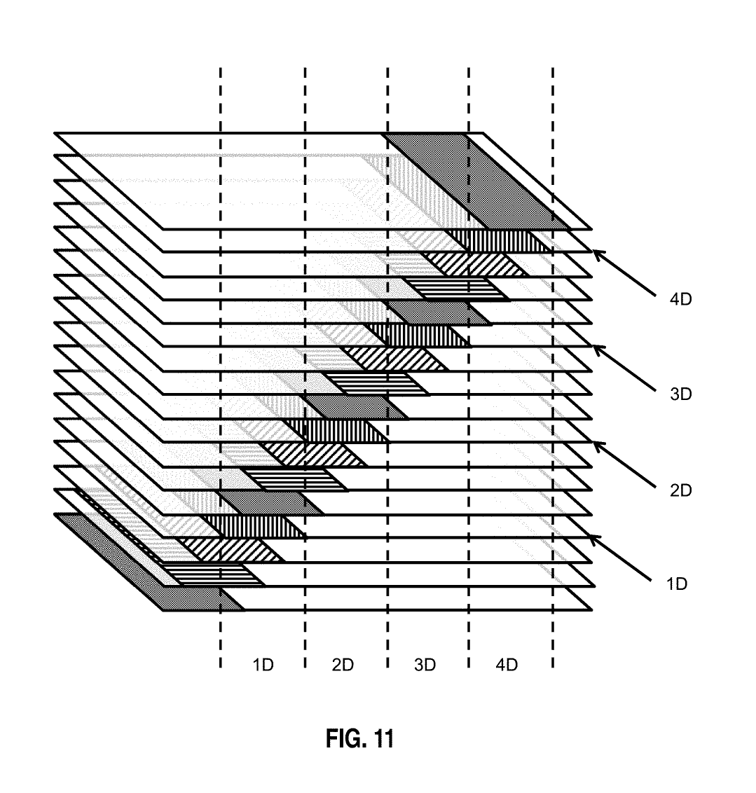

FIG. 8˜FIG. 11 show how the different depths of the images can be taken in the present invention. In FIG. 8, 4 different kinds of the depth to be scanned are illustrates. Each kind is illustrated with same texture of the area. In each plane, there is a stripe of the textured area, which shows line scan camera's image taking areas. Each same textured area, in FIG. 8, 1A, 2A, 3A, 4A, 5A are taken with same depth by the variable focus optical element. Here number notation represents order of each scan for same depth and alphabet notation represents depth of the image scan. Since the images are taken with same depth, those can be combined or stitched together to form a whole area image. At the bottom of figure each area was represented without overlap and missing area. With this scan, whole are scan of one depth can be obtained. With FIG. 8 scan, first depth image of whole are can be scanned.

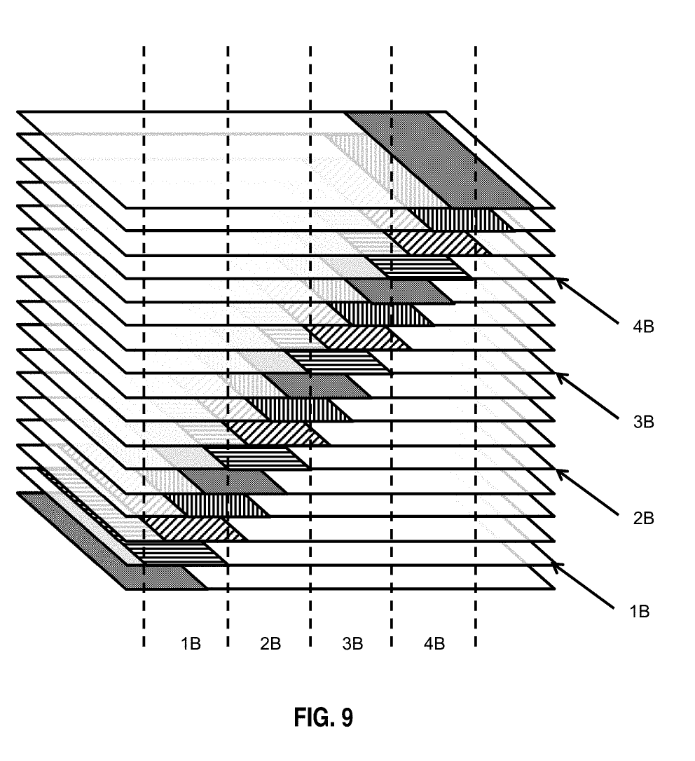

In FIG. 9, also 4 different kinds of the depth to be scanned are illustrates. Each kind is illustrated with same texture of the area. In each plane, there is a stripe of the textured area, which shows line scan camera's image taking areas. Each same textured area, in FIG. 9, 1B, 2B, 3B, 4B, 5B are taken with same depth by the variable focus optical element. Here number notation represents order of each scan for same depth and alphabet notation represents depth of the image scan. Since the images are taken with same depth, those can be combined or stitched together to form a whole area image. At the bottom of figure each area was represented without overlap and missing area. With this scan, whole are scan of one depth can be obtained. With FIG. 9 scan, second depth image of whole are can be scanned.

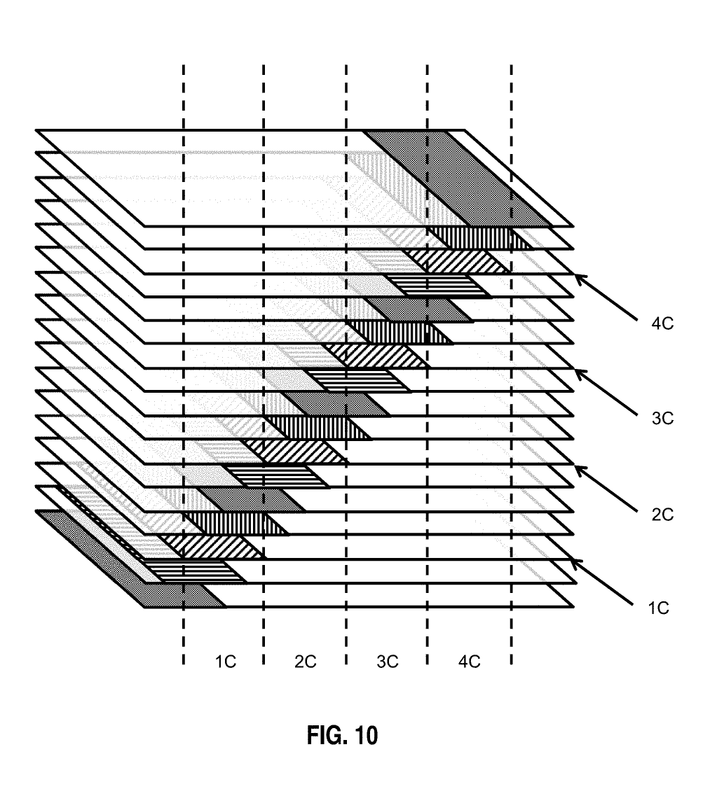

In FIG. 10, same 4 different kinds of the depth to be scanned are illustrates. Each kind is illustrated with same texture of the area. In each plane, there is a stripe of the textured area, which shows line scan camera's image taking areas. Each same textured area, in FIG. 10, 1C, 2C, 3C, 4C, 5C are taken with same depth by the variable focus optical element. Here number notation represents order of each scan for same depth and alphabet notation represents depth of the image scan. Since the images are taken with same depth, those can be combined or stitched together to form a whole area image. At the bottom of figure each area was represented without overlap and missing area. With this scan, whole are scan of one depth can be obtained. With FIG. 10 scan, third depth image of whole are can be scanned.

In FIG. 11, same 4 different kinds of the depth to be scanned are illustrates. Each kind is illustrated with same texture of the area. In each plane, there is a stripe of the textured area, which shows line scan camera's image taking areas. Each same textured area, in FIG. 11, 1D, 2D, 3D, 4D, 5D are taken with same depth by the variable focus optical element. Here number notation represents order of each scan for same depth and alphabet notation represents depth of the image scan. Since the images are taken with same depth, those can be combined or stitched together to form a whole area image. At the bottom of figure each area was represented without overlap and missing area. With this scan, whole are scan of one depth can be obtained.

While in FIG. 8˜FIG. 11 shows multi-depth scanning method, it is possible to have multiple scans with different optical conditions and parameters such as illumination conditions, color condition, and exposure condition or other parameters. If those conditions are changed with line camera scan, strobe-control of the parameters is highly recommended since it can reduce the time of the scan. With FIG. 8˜FIG. 11 scan, fourth different optical parameter conditions can be scanned. For example, in FIG. 8, scan can be used with one color, let's say Red. And in FIG. 9, Green, in FIG. 10, Blue, and in FIG. 11, near infrared (NIR) can be used as a scan parameter. With this scan all the visible color scan plus NIR can be scanned at the same time with only one scan of the line scan camera. Also changing intensity of the illumination is a good example of the parameter scan. As easily can be seen, mixture of the depth and parameter scans are also possible in the present invention.

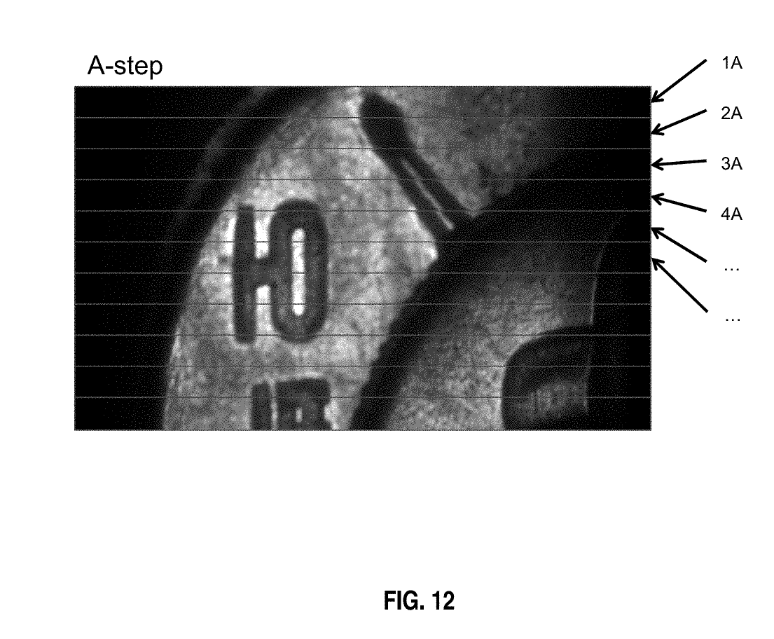

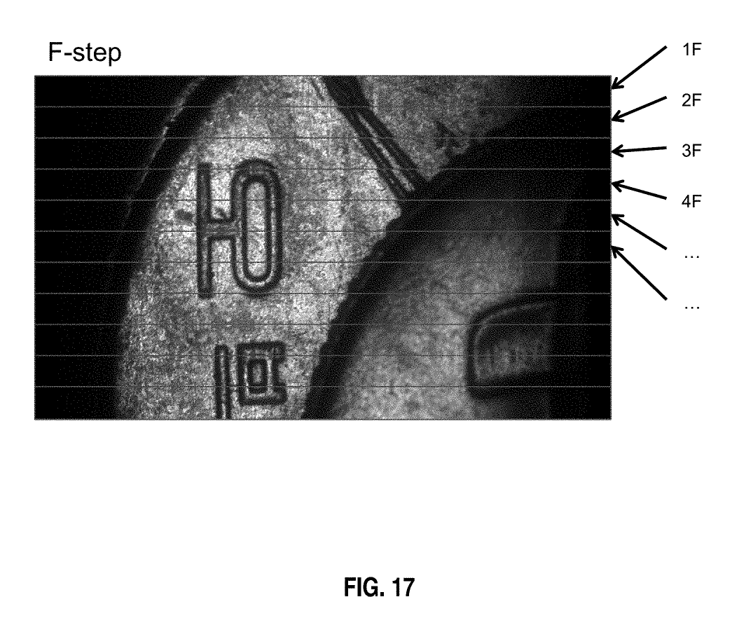

FIG. 12˜FIG. 17 show a real example of the depth scan of the present invention with varying the image focal plane to have depth scanning with the variable focus optical element. In FIG. 12, one depth scan images are combined together. As notation says, the first depth scan images are combined. Each area represents one image from the line camera with are scan mode (to express here more clearly, area scan is used). Each area has 256-pixel height and 16 k-pixel width, one of the best line scan camera in the current market. This images corresponds to the 1A, 2A, 3A, 4A, 5A, . . . in FIG. 8. And one depth step A is used for the specific scan. Focus is closely located at the top of the three dimensional objects (here coins). With combining (stitching) method, all the area can be combined. FIG. 12 is just stitched with images not using any algorithm. For this specific depth scan, the variable focus optical element uses its own specific depth (first) of the scan range to match with top of the objects. The corresponding schematic area of FIG. 8 in this scan are also shown with the same notation 1A, 2A, 3A, 4A, 5A, . . . . This FIG. 12 shows first depth of the scan image.

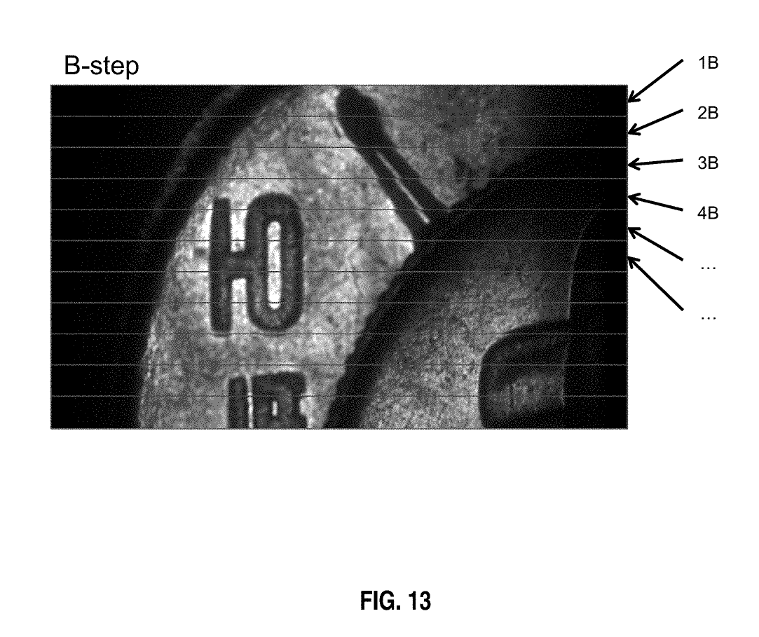

FIG. 13 shows a real example of the second depth scan of the present invention with varying the image focal plane to have depth scanning with the variable focus optical element. In FIG. 13, second depth scan images are combined together. As notation says, the second depth scan images are combined. Each area represents one image from the line camera with are scan mode (to express here more clearly, area scan is used). Each area has 256-pixel height and 16 k-pixel width, one of the best line scan camera in the current market. This images corresponds to the 1B, 2B, 3B, 4B, . . . in FIG. 9. And one depth step B is used for the specific scan. Focus is closely located at the top of the three dimensional objects slightly lower (here coins). With combining (stitching) method, all the area can be combined. FIG. 13 is just stitched with images not using any algorithm. For this specific depth scan, the variable focus optical element uses its own specific depth (second) of the scan range to match with top of the objects. The corresponding schematic area of FIG. 9 in this scan are also shown with the same notation 1B, 2B, 3B, 4B, 5B, . . . . This FIG. 13 shows second depth of the scan image.

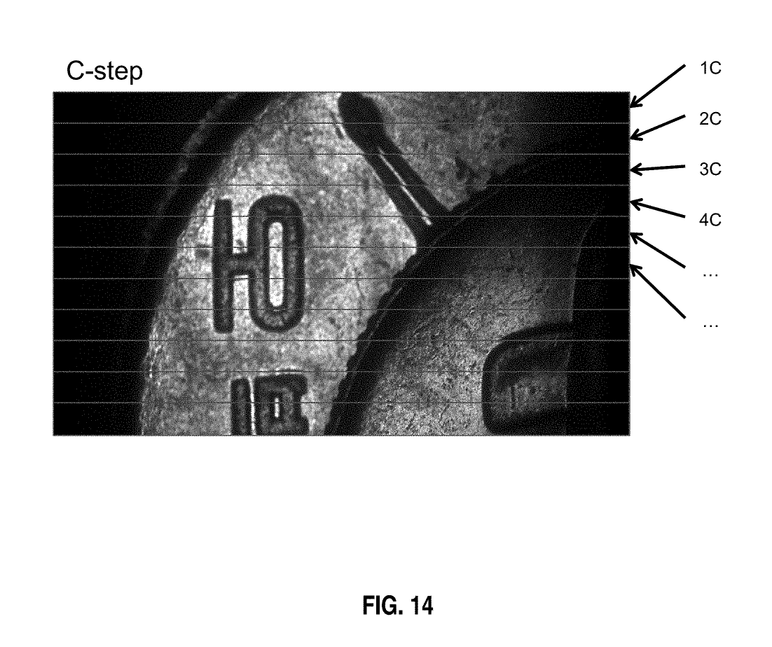

FIG. 14 shows a real example of the third depth scan of the present invention with varying the image focal plane to have depth scanning with the variable focus optical element. In FIG. 14, third depth scan images are combined together. As notation says, the third depth scan images are combined. Each area represents one image from the line camera with are scan mode (to express here more clearly, area scan is used). Each area has 256-pixel height and 16 k-pixel width, one of the best line scan camera in the current market. This images corresponds to the 1C, 2C, 3C, 4C, . . . in FIG. 10. And one depth step C is used for the specific scan. Focus is closely located at the top of the bottom coin. With combining (stitching) method, all the area can be combined. FIG. 14 is just stitched with images not using any algorithm. For this specific depth scan, the variable focus optical element uses its own specific depth (third) of the scan range to match with top of the objects. The corresponding schematic area of FIG. 10 in this scan are also shown with the same notation 1C, 2C, 3C, 4C, 5C, . . . . This FIG. 14 shows third depth of the scan image.

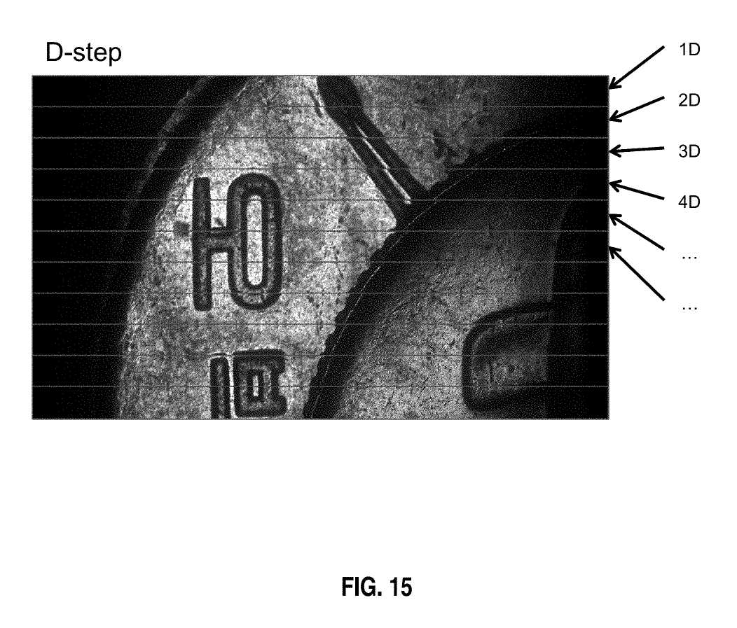

FIG. 15 shows a real example of the third depth scan of the present invention with varying the image focal plane to have depth scanning with the variable focus optical element. In FIG. 15, fourth depth scan images are combined together. As notation says, the fourth depth scan images are combined. Each area represents one image from the line camera with are scan mode (to express here more clearly, area scan is used). Each area has 256-pixel height and 16 k -pixel width, one of the best line scan camera in the current market. This images corresponds to the 1D, 2D, 3D, 4D, . . . in FIG. 11. And one depth step D is used for the specific scan. Focus is closely located at the top of the bottom coin slightly lower. With combining (stitching) method, all the area can be combined. FIG. 15 is just stitched with images not using any algorithm. For this specific depth scan, the variable focus optical element uses its own specific depth (fourth) of the scan range to match with top of the objects. The corresponding schematic area of FIG. 11 in this scan are also shown with the same notation 1D, 2D, 3D, 4D, 5D, . . . . This FIG. 15 shows third depth of the scan image.

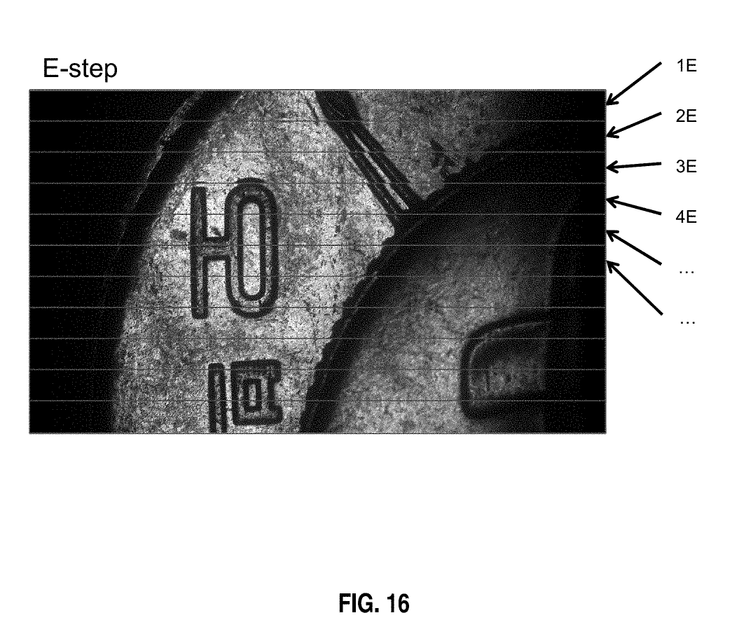

FIG. 16 and FIG. 17 show a real example of other depths scan of the present invention with varying the image focal plane to have depth scanning with the variable focus optical element. In FIG. 16, fifth depth scan images are combined together. As notation says, the fifth depth scan images are combined. Each area represents one image from the line camera with are scan mode (to express here more clearly, area scan is used). In FIG. 17, sixth depth scan images are combined together. As notation says, the sixth depth scan images are combined. Each area represents one image from the line camera with are scan mode (to express here more clearly, area scan is used). Each area has 256-pixel height and 16 k-pixel width, one of the best line scan camera in the current market. This images FIG. 16 and FIG. 17 corresponds to the depth of E and F which are not shown in FIG. 8˜FIG. 11. And one depth step E and F respectively is used for the specific scan. Focus is closely located at the middle of the bottom coin and bottom of the bottom coin respectively. With combining (stitching) method, all the area can be combined. FIG. 16 and FIG. 17 are just stitched with images not using any algorithm. For this specific depth scan, the variable focus optical element uses its own specific depth (fifth and sixth) of the scan range to match with top of the objects.

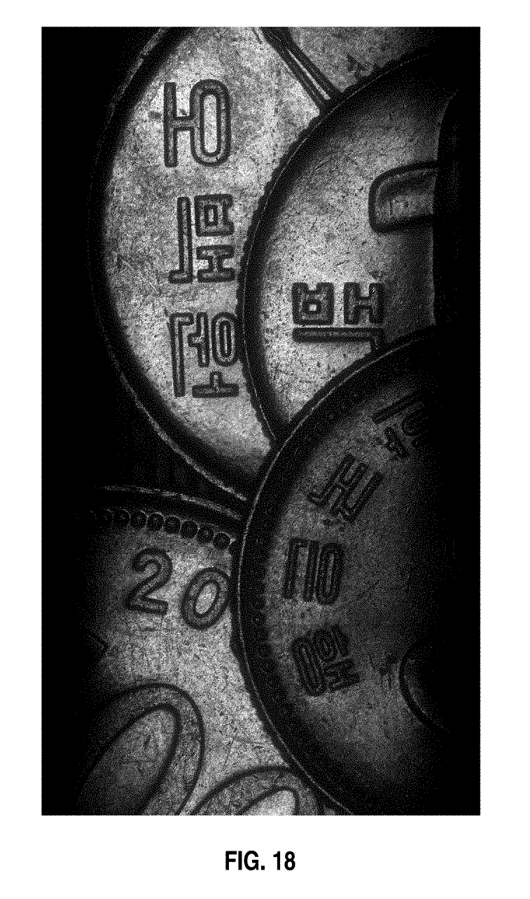

FIG. 18 shows an AIF (all in focused) image from the three dimensional imaging system with line scan camera, which is made of images from FIG. 12˜FIG. 17 (more depth images are used). Only 4 depths are mentioned in FIG. 8˜FIG. 11, and 6 depth images are shown in FIG. 12˜FIG. 17. But in the actual image of AIF, more depths are used to have better resolution of the depth of the system. As easily can be seen, all the areas are in focused in FIG. 18. From each depth scan and line (area) scans, only in-focused images are extracted and formed to an AIF image.

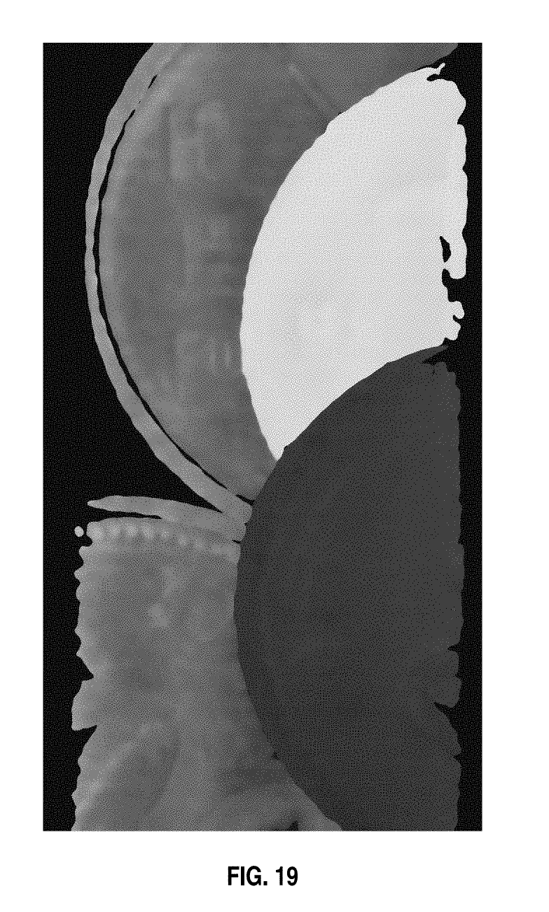

FIG. 19 shows a contour plot of depth-map from the three dimensional imaging system with line scan camera, which is made of images from FIG. 12˜FIG. 17 (more depth images are used). Before the three dimensional reconstruction, a depth-map is formed with scanned data. Each pixel has its own depth taken by the in-focused pixel depth. Using step of the variable focus optical element, the depth of the image can be calculated.

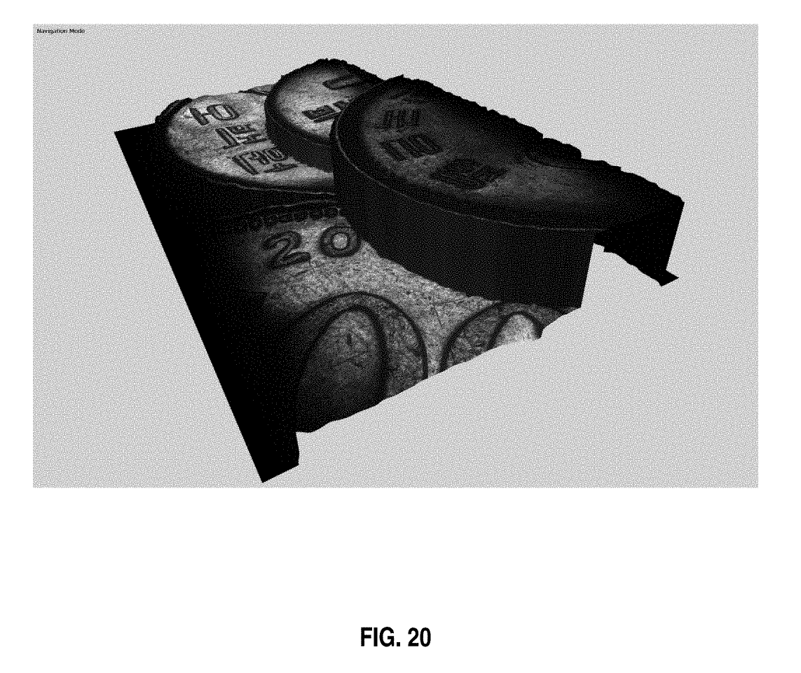

FIG. 20 shows a three dimensional reconstructed image of the object by the three dimensional imaging system with line scan camera, which is made of images from FIG. 12˜FIG. 17 (more depth images are used). With AIF image in FIG. 18 and depth-information in FIG. 19, each pixel of AIF image can have x and y location based on pixel position in the image. And by using depth information from the depth map in FIG. 19, third coordinate of z can be obtained. Thus all three dimensional information is formed for all the image pixels of the AIF image. Then three dimensional image reconstruction can be possible. With those information, FIG. 20 three dimensional image was reconstructed. As easily can be seen, all image pixels are in focus and the depth information is taken.

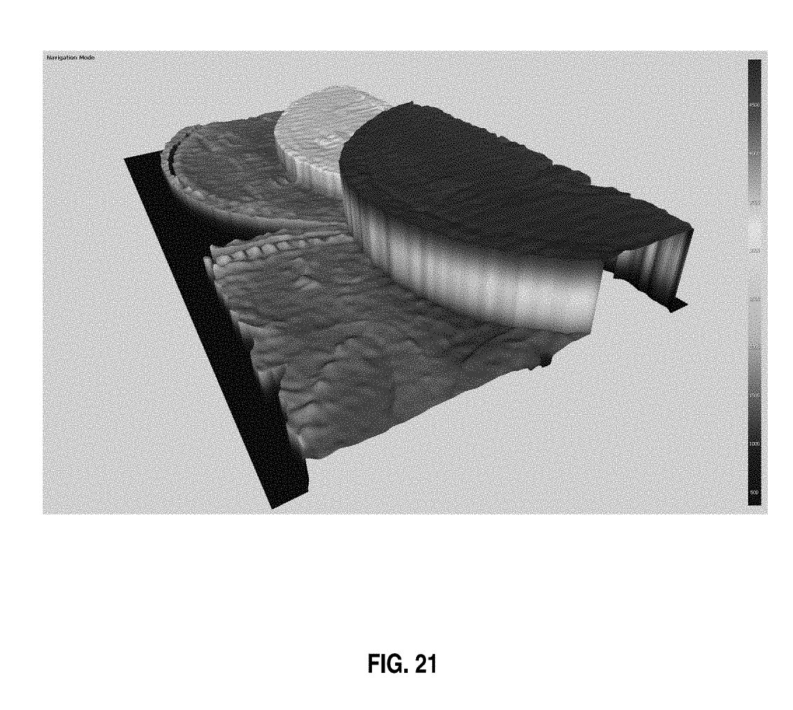

FIG. 21 shows a three dimensional reconstructed depth map of the object by the three dimensional imaging system with line scan camera, which is made of images from FIG. 12˜FIG. 17 (more depth images are used). Basically the same three dimensional reconstruction method is used as FIG. 20. In FIG. 21, color representation of the depth to make clear difference in depth is shown.

Three dimensional imaging system with line scan camera of the present invention comprises a line scan camera, an imaging optics wherein the imaging optics determines base optical power of the three dimensional imaging system with line scan camera, a variable focus optical element wherein the variable focus optical element changes focal plane of the imaging system, and a scanning device wherein the scanning device moves the line scan camera or objects (an object) relatively with each other, wherein one of the line scan camera or the objects is moved for relative motion, wherein said variable focus optical element scans objects in optical depth dimension and the line scan camera scans the objects with relative motion of the line scan camera and the objects.

The line scan camera of the present invention is coupled with variable focus optical element. The line scan camera of the present invention alternatively captures depth images varying images with changing the focal plane of the imaging system. The imaging optics of the present invention images the object onto the line scan camera through the variable focus optical element.

The variable focus optical element of the present invention varies base optical power of the three dimensional imaging system. The variable focus optical element of the present invention comprises a variable focus lens. The variable focus optical element of the present invention comprises a variable focus mirror. The variable focus optical element of the present invention comprises a Micromirror Array Lens, wherein the Micromirror Array Lens satisfy phase matching condition and convergence condition of the optical system.

The line scan camera of the present invention comprises a stripe type area mode. the line scan camera of the present invention scans depth scan happens while the scan area changes. The variable focus optical element of the present invention changes focal plane while passing the strip type area in the line scan camera without building un-scanned area. The variable focus optical element of the present invention changes focal plane so that the line scan camera and the scanning device minimize un-scanned area of the system.

The present invention also discloses a method for three dimensional image taking by three dimensional imaging system with line scan camera comprising: determining base optical power of the three dimensional imaging system based on objects (an object) to be imaged; scanning relative position of the objects and a line scan camera, wherein the objects or the line scan move for scanning imaging field of view; changing focal plane of the variable focus optical element, wherein the variable focus optical element is coupled with scanning the relative position of the objects and the line scan camera; and taking images based on the focal plane of the variable focus optical element, wherein the taken images are processed to extract three dimensional information of the objects.

The method for three dimensional image taking by three dimensional imaging system with line scan camera of the present invention further comprises repeating focal plane changes for taking same depth images of the objects. The method for three dimensional image taking by three dimensional imaging system with line scan camera of the present invention further comprises changing optical parameters or the system. In the method for three dimensional image taking by three dimensional imaging system with line scan camera of the present invention, the optical parameters are illumination condition, exposure time, numerical aperture or focal distance of the imaging system.

The present invention of three dimensional imaging system with line scan camera comprises a line scan camera, an imaging optics wherein the imaging optics determines base optical power of the three dimensional imaging system with line scan camera, a mean for changing optical parameter of the system wherein the mean form changing optical parameter is coupled with the line scan camera, and a scanning device wherein the scanning device moves the line scan camera or objects (an object) relatively with each other, wherein one of the line scan camera or the objects is moved for relative motion, wherein said variable focus optical element scans objects in optical depth dimension and the line scan camera scans the objects with relative motion of the line scan camera and the objects.

The line scan camera of the present invention alternatively captures images with varying optical parameters such as illumination condition, exposure time, numerical aperture or focal distance of the imaging system. The three dimensional imaging system of the present invention further comprise a variable focus optical element. The imaging optics of the present invention images the object onto the line scan camera through the variable focus optical element.

The variable focus optical element of the present invention varies base optical power of the three dimensional imaging system. The variable focus optical element of the present invention comprises a variable focus lens. The variable focus optical element of the present invention comprises a variable focus mirror. The variable focus optical element comprises a Micromirror Array Lens, wherein the Micromirror Array Lens satisfies phase matching condition and convergence condition.

The line scan camera of the present invention comprises a stripe type area mode. The mean for changing optical parameter of the system of the present invention changes the optical parameters while the scan area changes. the mean for changing optical parameter of the system changes the optical parameter so that the scanning device and the line scan camera minimize un-scanned area of the system.

Even though the property of the Micromirror Array Lens is briefly disclosed in the present invention, the detail about the Micromirror Array Lens is disclosed in the following patents. The general principle and methods for making the Micromirror Array Lens are disclosed in U.S. Pat. No. 6,934,072 issued Aug. 23, 2005 to Kim, U.S. Pat. No. 6,934,073 issued Aug. 23, 2005 to Kim, U.S. Pat. No. 6,970,284 issued Nov. 29, 2005 to Kim, U.S. Pat. No. 6,999,226 issued Feb. 14, 2006 to Kim, U.S. Pat. No. 7,031,046 issued Apr. 18, 2006 to Kim, U.S. Pat. No. 7,095,548 issued Aug. 22, 2006 to Cho, U.S. Pat. No. 7,161,729 issued Jan. 9, 2007 to Kim, U.S. Pat. No. 7,239,438 issued Jul. 3, 2007 to Cho, U.S. Pat. No. 7,267,447 issued Sep. 11, 2007 to Kim, U.S. Pat. No. 7,274,517 issued Sep. 25, 2007 to Cho, U.S. Pat. No. 7,489,434 issued Feb. 10, 2009 to Cho, U.S. Pat. No. 7,619,807 issued Nov. 17, 2009 to Baek, and U.S. Pat. No. 7,777,959 issued Aug. 17, 2010 to Sohn, all of which are incorporated herein by references.

The general principle, structure and methods for making the micromirror array devices and Micromirror Array Lens are disclosed in U.S. Pat. No. 7,330,297 issued Feb. 12, 2008 to Noh, U.S. Pat. No. 7,365,899 issued Apr. 29, 2008 to Gim, U.S. Pat. No. 7,382,516 issued Jun. 3, 2008 to Seo, U.S. Pat. No. 7,400,437 issued Jul. 15, 2008 to Cho, U.S. Pat. No. 7,411,718 issued Aug. 12, 2008 to Cho, U.S. Pat. No. 7,474,454 issued Jan. 6, 2009 to Seo, U.S. Pat. No. 7,488,082 issued Feb. 10, 2009 to Kim, U.S. Pat. No. 7,535,618 issued May 19, 2009 to Kim, U.S. Pat. No. 7,589,884 issued Sep. 15, 2009 to Sohn, U.S. Pat. No. 7,589,885 issued Sep. 15, 2009 to Sohn, U.S. Pat. No. 7,605,964 issued Oct. 20, 2009 to Gim, U.S. Pat. No. 7,777,959 issued Aug. 17, 2010 to Sohn, U.S. Pat. No. 7,898,144 issued Mar. 1, 2011 to Seo, U.S. Pat. No. 8,687,276 issued Apr. 1, 2014 to Cho, U.S. Pat. No. 9,505,606 issued Nov. 29, 2016 to Sohn, and U.S. Pat. Pub. No 2009/0303569 published Dec. 10, 2009, all of which are incorporated herein by references.

The general properties of the Micromirror Array Lens are disclosed in U.S. Pat. No. 7,173,653 issued Feb. 6, 2007 to Gim, U.S. Pat. No. 7,215,882 issued May 8, 2007 to Cho, U.S. Pat. No. 7,236,289 issued Jun. 26, 2007 to Baek, U.S. Pat. No. 7,354,167 issued Apr. 8, 2008 to Cho, U.S. Pat. No. 9,565,340 issued Feb. 7, 20017 to Seo, U.S. Pat. No. 9,736,346 issued Aug. 15, 2017 to Baek, all of which are incorporated herein by references.

The general principle, methods for making the micromirror array devices and Micromirror Array Lens, and their applications are disclosed in U.S. Pat. No. 7,057,826 issued Jun. 6, 2006 to Cho, U.S. Pat. No. 7,068,416 issued Jun. 27, 2006 to Gim, U.S. Pat. No. 7,077,523 issued Jul. 18, 2006 to Seo, U.S. Pat. No. 7,212,330 issued May 1, 2007 to Seo, U.S. Pat. No. 7,261,417 issued Aug. 28, 2007 to Cho, U.S. Pat. No. 7,315,503 issued Jan. 1, 2008 to Cho, U.S. Pat. No. 7,333,260 issued Feb. 19, 2008 to Cho, U.S. Pat. No. 7,339,746 issued Mar. 4, 2008 to Kim, U.S. Pat. No. 7,350,922 issued Apr. 1, 2008 to Seo, U.S. Pat. No. 7,410,266 issued Aug. 12, 2008 to Seo, U.S. Pat. No. 7,580,178 issued Aug. 25, 2009 to Cho, U.S. Pat. No. 7,605,989 issued Oct. 20, 2009 to Sohn, U.S. Pat. No. 7,619,614 issued Nov. 17, 2009 to Baek, U.S. Pat. No. 7,667,896 issued Feb. 23, 2010 to Seo, U.S. Pat. No. 7,742,232 issued Jun. 22, 2010 to Cho, U.S. Pat. No. 7,751,694 issued Jul. 6, 2010 to Cho, U.S. Pat. No. 7,768,571 issued Aug. 3, 2010 to Kim, U.S. Pat. No. 8,049,776 issued Nov. 1, 2011 to Cho, U.S. Pat. No. 8,345,146 issued Jan. 1, 2013 to Cho, U.S. Pat. No. 8,622,557 issued Jan. 7, 2014 to Cho, U.S. Pat. No. 8,810,908 issued Aug. 19, 2014 to Kim, U.S. Pat. Pub. No. 2006/0203117 published Sep. 14, 2006, U.S. Pat. Pub. No. 2007/0041077 published Feb. 22, 2007, U.S. Pat. Pub. No. 2007/0040924 published Feb. 22, 2007, U.S. Pat. Pub. No. 2009/0185067 published Jul. 23, 2009, U.S. Pat. Pub. No. 2012/0133761 published May 31, 2012, and U.S. patent application Ser. No. 15/333,188 filed Oct. 25, 2016, all of which are incorporated herein by references.

The general principle, structure and methods for making the discrete motion control of MEMS device are disclosed in U.S. Pat. No. 7,330,297 issued Feb. 12, 2008 to Noh, U.S. Pat. No. 7,365,899 issued Apr. 29, 2008 to Gim, U.S. Pat. No. 7,382,516 issued Jun. 3, 2008 to Seo, U.S. Pat. No. 7,400,437 issued Jul. 15, 2008 to Cho, U.S. Pat. No. 7,411,718 issued Aug. 12, 2008 to Cho, U.S. Pat. No. 7,474,454 issued Jan. 6, 2009 to Seo, U.S. Pat. No. 7,488,082 issued Feb. 10, 2009 to Kim, U.S. Pat. No. 7,535,618 issued May 19, 2009 to Kim, U.S. Pat. No. 7,589,884 issued Sep. 15, 2009 to Sohn, U.S. Pat. No. 7,589,885 issued Sep. 15, 2009 to Sohn, U.S. Pat. No. 7,605,964 issued Oct. 20, 2009 to Gim, U.S. Pat. No. 7,777,959 issued Aug. 17, 2010 to Sohn, U.S. Pat. No. 7,898,144 issued Mar. 1, 2011 to Seo, and U.S. Pat. No. 9,505,606 issued Nov. 29, 2016 to Sohn, all of which are incorporated herein by references.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. A three dimensional imaging system with line scan camera comprising:
a. a line scan camera;
b. an imaging optics wherein the imaging optics determines base optical power of the three dimensional imaging system with line scan camera;
c. a variable focus optical element wherein the variable focus optical element changes focal plane of the imaging system; and
d. a scanning device wherein the scanning device moves the line scan camera or objects (an object) relatively with each other, wherein one of the line scan camera or the objects is moved for relative motion;
wherein said variable focus optical element scans objects in optical depth dimension and the line scan camera scans the objects with relative motion of the line scan camera and the objects.

2. The three dimensional imaging system with line scan camera in claim 1, wherein the line scan camera is coupled with variable focus optical element.

3. The three dimensional imaging system with line scan camera in claim 1, wherein the line scan camera alternatively captures depth images varying images with changing the focal plane of the imaging system.

4. The three dimensional imaging system with line scan camera in claim 1, wherein the imaging optics images the object onto the line scan camera through the variable focus optical element.

5. The three dimensional imaging system with line scan camera in claim 1, wherein the variable focus optical element varies base optical power of the three dimensional imaging system.

6. The three dimensional imaging system with line scan camera in claim 1, wherein the variable focus optical element comprises a variable focus lens.

7. The three dimensional imaging system with line scan camera in claim 1, wherein the variable focus optical element comprises a variable focus mirror.

8. The three dimensional imaging system with line scan camera in claim 1, wherein the variable focus optical element comprises a Micromirror Array Lens.

9. The three dimensional imaging system with line scan camera in claim 1, wherein the line scan camera comprises a stripe type area mode.

10. The three dimensional imaging system with line scan camera in claim 9, wherein the line scan camera scans depth scan happens while the scan area changes.

11. The three dimensional imaging system with line scan camera in claim 9, wherein the variable focus optical element changes focal plane while passing the strip type area in the line scan camera without building un-scanned area.

12. The three dimensional imaging system with line scan camera in claim 9, wherein the variable focus optical element changes focal plane so that the line scan camera and the scanning device minimize un-scanned area of the system.

13. A method for three dimensional image taking by three dimensional imaging system with line scan camera comprising:
a. determining base optical power of the three dimensional imaging system based on objects (an object) to be imaged;
b. scanning relative position of the objects and a line scan camera, wherein the objects or the line scan move for scanning imaging field of view;
c. changing focal plane of the variable focus optical element, wherein the variable focus optical element is coupled with scanning the relative position of the objects and the line scan camera; and
d. taking images based on the focal plane of the variable focus optical element;
wherein the taken images are processed to extract three dimensional information of the objects.

14. The method for three dimensional image taking by three dimensional imaging system with line scan camera in claim 13 further comprises repeating focal plane changes for taking same depth images of the objects.

15. The method for three dimensional image taking by three dimensional imaging system with line scan camera in claim 13 further comprises changing optical parameters of the system.

16. The method for three dimensional image taking by three dimensional imaging system with line scan camera in claim 15, wherein the optical parameters are illumination condition, exposure time, numerical aperture or focal distance of the imaging system.

17. A three dimensional imaging system with line scan camera comprising:
a. a line scan camera;
b. an imaging optics wherein the imaging optics determines base optical power of the three dimensional imaging system with line scan camera;
c. a mean for changing optical parameter of the system wherein the mean form changing optical parameter is coupled with the line scan camera; and
d. a scanning device wherein the scanning device moves the line scan camera or objects (an object) relatively with each other, wherein one of the line scan camera or the objects is moved for relative motion;
wherein said variable focus optical element scans objects in optical depth dimension and the line scan camera scans the objects with relative motion of the line scan camera and the objects.

18. The three dimensional imaging system with line scan camera in claim 17, wherein the line scan camera alternatively captures images with varying optical parameters such as illumination condition, exposure time, numerical aperture or focal distance of the imaging system.

19. The three dimensional imaging system with line scan camera in claim 17, wherein the three dimensional imaging system further comprise a variable focus optical element.

20. The three dimensional imaging system with line scan camera in claim 19, wherein the imaging optics images the object onto the line scan camera through the variable focus optical element.

21. The three dimensional imaging system with line scan camera in claim 19, wherein the variable focus optical element varies base optical power of the three dimensional imaging system.

22. The three dimensional imaging system with line scan camera in claim 19, wherein the variable focus optical element comprises a variable focus lens.

23. The three dimensional imaging system with line camera in claim 19, wherein the variable focus optical element comprises a variable focus mirror.

24. The three dimensional imaging system with line scan camera in claim 19, wherein the variable focus optical element comprises a Micromirror Array Lens.

25. The three dimensional imaging system with line scan camera in claim 17, wherein the line scan camera comprises a stripe type area mode.

26. The three dimensional imaging system with line scan camera in claim 25, wherein the mean for changing optical parameter of the system changes the optical parameters while the scan area changes.

27. The three dimensional imaging system with line scan camera in claim 25, wherein the mean for changing optical parameter of the system changes the optical parameter so that the scanning device and the line scan camera minimize un-scanned area of the system.
